(19) United States
(12) Patent Application Publication
(10) Pub. No.: US 2008/0027360 A1
(43) Pub. Date: Jan. 31, 2008

(54) Medical device for temporarily treating flail chest injury

(76) Inventor: George K. Smith, Brandon, MS (US)

Correspondence Address: JAMES RAY & ASSOCIATES, 2640 PITCAIRN ROAD, MONROEVILLE, PA, 15146, US

(21) Appl. No.: 11/881,027

(22) Filed: Jul. 25, 2007

Related U.S. Application Data
(60) Provisional application No. 60/833,050, filed on Jul. 25, 2006.

(51) Int. Cl. A61H 31/00

(52) U.S. Cl. 601/44

(57) ABSTRACT

A medical device for temporarily treating an individual having a flail chest injury prior to and during transport of the individual for further medical treatment. The medical device includes a flexible member engageable with a flail segment of an individual that provides skin traction to the flail segment of the individual for stabilizing paradoxical motion of such flail segment during respiration. There is an adhesive layer disposed on the flexible member for temporarily adhering it to the flail segment of the individual.

### CROSS REFERENCE TO RELATED APPLICATION

This application is closely related to and claims priority from U.S. Provisional Patent Application Ser. No. 60/833,050 filed on Jul. 25, 2006.

### FIELD OF THE INVENTION

The present invention relates, in general, to medical devices used to treat various chest related injuries and, more particularly, the invention relates to a medical device for temporarily treating an individual having a flail chest injury prior to and during transport of such individual for further medical treatment.

### BACKGROUND OF THE INVENTION

The following information on flail chest injuries is from Wikipedia®, a registered trademark of the Wikimedia Foundation, Inc. A flail chest injury occurs when a segment of the thoracic wall breaks under extreme stress and becomes detached from the rest of the chest wall. This typically occurs when three or more ribs are fractured in two or more places, allowing that segment of the thoracic wall to displace and move independently of the rest of the chest wall.

The characteristic paradoxical motion of the flail segment occurs due to pressure changes associated with respiration that the rib cage normally resists. During inspiration, the diaphragm contracts and intercostal muscles push the rib cage out. Pressure in the thorax decreases below atmospheric pressure, and air rushes in through the trachea. However, a flail segment will not resist the decreased pressure and will appear to push in while the rest of the rib cage expands. During expiration, the diaphragm and intercostal muscles relax, allowing the abdominal organs to push air upwards and out of the thorax. However, a flail segment will also be pushed out while the rest of the rib cage contracts.

The constant motion of the ribs in the flail segment at the site of the fracture is exquisitely painful, and the sharp broken edges of the ribs can eventually puncture the pleural sac and lung, which may be fatal.

### SUMMARY OF THE INVENTION

The present invention provides a medical device for temporarily treating an individual having a flail chest injury prior to and during transport of the individual for further medical treatment. The medical device includes a flexible member engageable with a flail segment of an individual that provides skin traction to the flail segment of the individual for stabilizing paradoxical motion of such flail segment during respiration. There is an adhesive layer disposed on the flexible member for temporarily adhering such flexible member to the flail segment of the individual.

### OBJECTS OF THE INVENTION

It is, therefore, a primary object of the present invention to provide a medical device that temporarily attaches to a flail segment of an individual to stabilize paradoxical motion of such flail segment during respiration.

Another object of the present invention is to provide a medical device that has indicia thereon which identifies such individual as having a flail chest injury.

Still another object of the present invention is to provide a medical device for a flail chest injury that is relatively inexpensive.

Yet another object of the present invention is to provide a medical device that is simple to apply to a flail chest injury.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an exploded side view of a medical device for a flail chest injury according to the present invention; and

FIG. 2 is a perspective view of the medical device, illustrated in FIG. 1, attached to a person having a flail chest injury.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

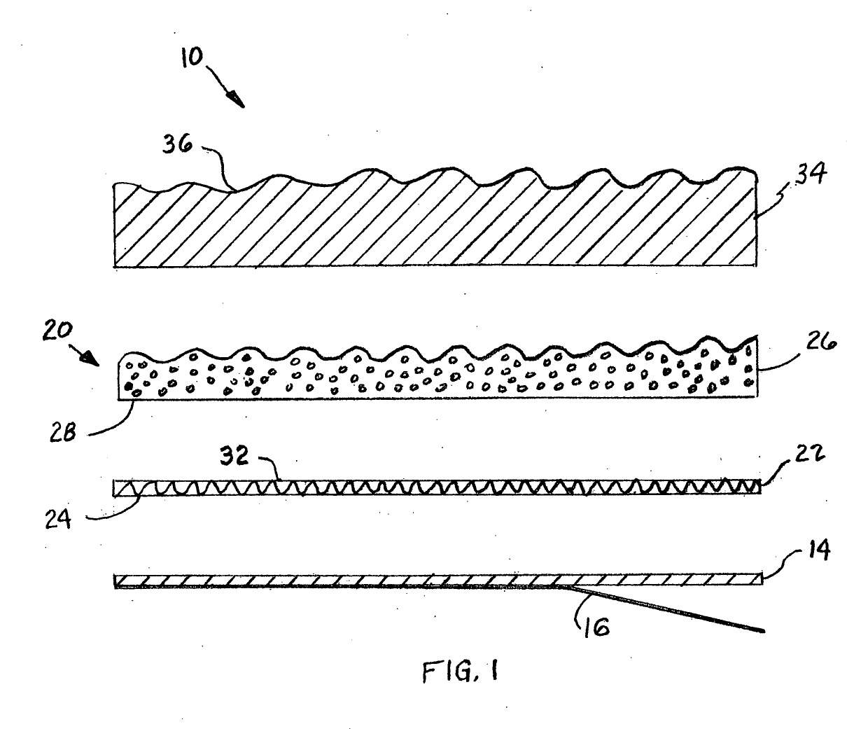

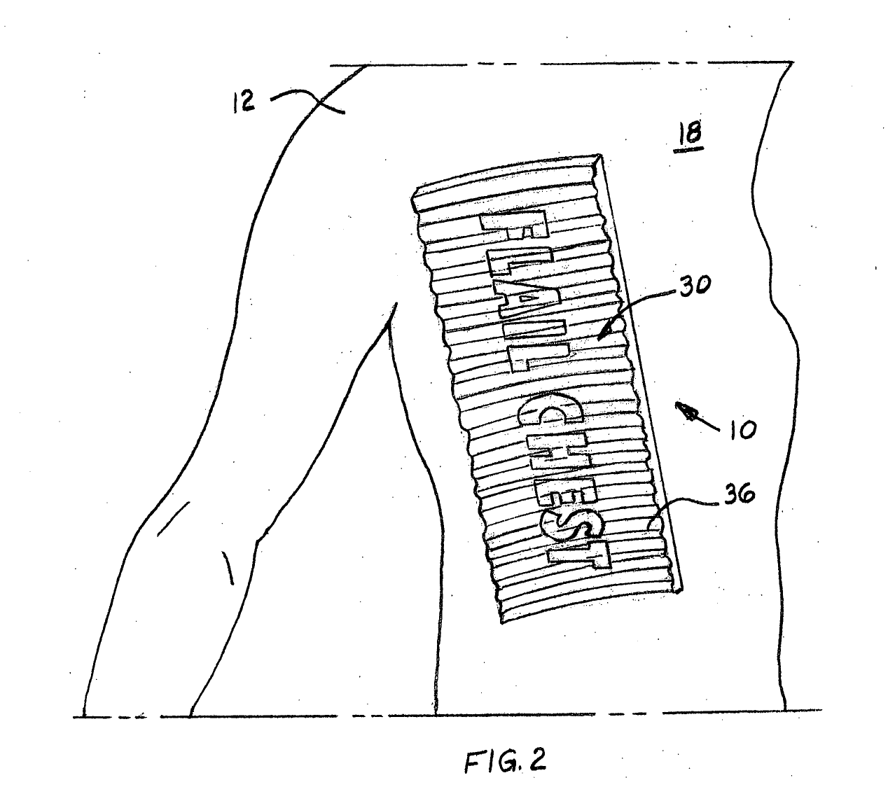

Reference is now made, more particularly, to drawing FIGS. 1 and 2. Illustrated therein is a medical device, generally designated 10, for temporarily treating a person 12 having a flail chest injury prior to and during transport of the person 12 for further medical treatment.

The medical device 10 includes a flexible member, generally designated 20, engageable with a flail segment of person 12 that provides skin traction to such flail segment of person 12 for stabilizing paradoxical motion of such flail segment during respiration.

There is an adhesive layer 14 disposed on the flexible member 20 for temporarily adhering flexible member 20 to the flail segment of person 12. The adhesive 14 is, preferably, an occlusive adhesive.

Medical device 10 may further include a removable plastic film 16 disposed over adhesive layer 14 for covering adhesive 14 prior to the application of flexible member 20 to the person's chest 18.

The flexible member 20 includes a cardboard layer 22 having adhesive layer 14 disposed on a bottom surface 24 thereof. A foam layer 26 having a bottom surface 28 is disposed on a top surface 32 of cardboard layer 22. Finally, an impermeable plastic layer 34 is disposed over each of cardboard layer 22 and foam layer 26.

Medical device 10 may further include indicia, generally designated 30, disposed on a top surface 36 of impermeable plastic layer 34 that identifies person 12 as having a flail chest injury.

Preferably, indicia 30 will include the words “FLAIL CHEST” in black letters over a bright orange background. However, the colors used for the letters and background could include a number of various combinations as long as the indicia 30 is easily discernable by medical personnel treating the patient.

Medical device 10 will, preferably, be disposable and designed in adult and pediatric sizes, such as 2″×6″, 3″×7″, 4″×9″ and 5″×11″.

The medical device 10 is perfect for use by fire department personnel, air and ground ambulance services, critical care transport teams and emergency room personnel prior to and during transport of patient for further medical treatment.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A medical device for temporarily treating an individual having a flail chest injury prior to and during transport of such individual for further medical treatment, said medical device comprising:
(a) a flexible member engageable with a flail segment of an individual that provides skin traction to such flail segment of such individual for stabilizing paradoxical motion of such flail segment during respiration; and
(b) an adhesive layer disposed on said flexible member for temporarily adhering said flexible member to such flail segment of such individual.

2. A medical device, according to claim 1, wherein said flexible member includes:
(a) a cardboard layer having said adhesive layer disposed on a bottom surface thereof;
(b) a foam layer having a bottom surface disposed on a top surface of said cardboard layer; and
(c) an impermeable plastic layer disposed over each of said cardboard and foam layers.

3. A medical device, according to claim 2, wherein said medical device further includes indicia disposed on a top surface of said impermeable plastic layer that identifies such individual as having a flail chest injury.

4. A medical device, according to claim 1, wherein said adhesive is an occlusive adhesive.

5. A medical device, according to claim 1, wherein said medical device further includes a removable plastic film disposed over said adhesive layer for covering said adhesive layer prior to application of said flexible member to such individual's chest.

6. A medical device, according to claim 1, wherein a size of said flexible member is one of 2″×6″, 3″×7″, 4″×9″ and 5″×11″.

7. A medical device, according to claim 1, wherein said medical device is disposable.

8. A medical device for temporarily treating an individual having a flail chest injury prior to and during transport of such individual for further medical treatment, said medical device comprising:
(a) a flexible member engageable with a flail segment of an individual that provides skin traction to such flail segment of such individual for stabilizing paradoxical motion of such flail segment during respiration, said flexible member including;
(i) a cardboard layer,
(ii) a foam layer having a bottom surface disposed on a top surface of said cardboard layer, and
(iii) an impermeable plastic layer disposed over each of said cardboard and foam layers;
(b) indicia disposed on a top surface of said impermeable plastic layer for identifying such individual as having a flail chest injury; and
(c) an adhesive layer disposed on a bottom surface of said cardboard layer for temporarily adhering said flexible member to such flail segment of such individual.

9. A medical device, according to claim 8, wherein said adhesive is an occlusive adhesive.

10. A medical device, according to claim 8, wherein said medical device further includes a removable plastic film disposed on said adhesive layer for covering said adhesive layer prior to application of said flexible member to such individual's chest.

11. A medical device, according to claim 8, wherein a size of said flexible member is one of 2″×6″, 3″×7″, 4″×9″ and 5″×11″.

12. A medical device, according to claim 8, wherein said medical device is disposable.
